(19) United States
(12) Patent Application Publication
(10) Pub. No.: US 2025/0356824 A1
(43) Pub. Date: Nov. 20, 2025

(54) DETECTION DEVICE AND DETECTION METHOD

(71) Applicant: Sony Group Corporation, Tokyo (JP)

(72) Inventors: Yuki OGASAWARA, Tokyo (JP); Hayato NISHIOKA, Tokyo (JP); Shinichi FURUYA, Tokyo (JP)

(73) Assignee: Sony Group Corporation, Tokyo (JP)

(21) Appl. No.: 18/854,550

(22) PCT Filed: Apr. 24, 2023
(86) PCT No.: PCT/JP2023/016031

§ 371 Date: Oct. 7, 2024

(30) Foreign Application Priority Data
May 2, 2022 (JP) 2022-076310

(51) Int. Cl. G10G 7/00; G10C 3/26

(52) U.S. Cl. CPC G10G 7/00; G10C 3/26

(57) ABSTRACT

A detection device according to an embodiment includes a casing, a fastener that is included in the casing and removably fixes the casing to a pedal for assistance for playing a piano, and a sensor that is included in the casing and detects an attitude of the casing. A detection method according to the present disclosure is executed by a processor, and the method includes a calculation step of calculating a pedaling angle of a pedal for assistance for playing a piano, on the basis of an output from a sensor of a detection device including a casing, a fastener included in the casing to removably fix the casing to the pedal for assistance for playing the piano, and a sensor included in the casing to detect an attitude of the casing.

### FIELD

The present disclosure relates to a detection device and a detection method.

### BACKGROUND

In playing a piano, not only playing the keyboard but also assistance for playing the piano by using a pedal such as a damper pedal is important. In Patent Literature 1, a configuration is described in which an amount of pedaling of an assistance pedal for playing the piano is detected by a displacement sensor mounted to a pedal rod vertically moving according to pressing of the pedal. Applying the configuration of Patent Literature 1 to display, for example, the detected amount of pedaling makes it possible to evaluate the amount of pedaling while playing the piano and improve playing technique.

### CITATION LIST

### Patent Literature

Patent Literature 1: JP 2000-259148 A

### SUMMARY

### Technical Problem

Meanwhile, the shape of a lyre to which the displacement sensor is fixed or a relative position between the pedal rod and the lyre differs depending on, for example, the model of the piano. Therefore, the configuration of Patent Literature 1 has poor versatility for mounting the displacement sensor.

A detection method according to the present disclosure is executed by a processor, and the method includes a calculation step of calculating a pedaling angle of a pedal for assistance for playing a piano, on the basis of an output from a sensor of a detection device including a casing, a fastener included in the casing to removably fix the casing to the pedal for assistance for playing the piano, and a sensor included in the casing to detect an attitude of the casing.

An object of the present disclosure is to provide a detection device and a detection method that are configured to readily detect an amount of pedaling of an assistance pedal.

### Solution to Problem

For solving the problem described above, a detection device according to one aspect of the present disclosure has a casing; a fastener that is included in the casing and removably fixes the casing to at least one pedal for assistance for playing a piano; and a sensor that is included in the casing and detects an attitude of the casing.

### BRIEF DESCRIPTION OF DRAWINGS

FIG. 1A is a schematic diagram illustrating an overview of a detection device according to an embodiment.

FIG. 1B is a schematic diagram illustrating an overview of the detection device according to the embodiment.

FIG. 1C is a schematic diagram illustrating an overview of the detection device according to the embodiment.

FIG. 2 is a schematic diagram illustrating an exemplary configuration of a detection system according to an embodiment.

FIG. 3 is a functional block diagram illustrating exemplary functions of a signal processing device according to an embodiment.

FIG. 4 is a functional block diagram illustrating exemplary functions of an information processing device according to an embodiment.

FIG. 5 is a block diagram illustrating an exemplary hardware configuration of a signal processing device applicable to an embodiment.

FIG. 6 is a block diagram illustrating an exemplary hardware configuration of an information processing device applicable to an embodiment.

FIG. 7A is a schematic diagram illustrating an exemplary structure of a fastener according to an embodiment.

FIG. 7B is a schematic diagram illustrating an exemplary structure of the fastener according to the embodiment.

FIG. 8 is schematic diagrams each illustrating an action of the fastener according to an embodiment.

FIG. 9 is schematic diagrams illustrating an exemplary structure of protrusions according to an embodiment.

FIG. 10 is schematic diagrams each illustrating mounting of a sensor on a casing according to an embodiment.

FIG. 11 is schematic diagrams each illustrating an inclined state of a casing according to an embodiment.

FIG. 12 is schematic diagrams each illustrating an inclined state of a casing according to an embodiment.

FIG. 13A is schematic diagrams each illustrating an example of a shape of a pedal.

FIG. 13B is schematic diagrams each illustrating an example of a shape of a pedal.

FIG. 13C is schematic diagrams each illustrating an example of a shape of a pedal.

FIG. 13D is schematic diagrams each illustrating an example of a shape of a pedal.

FIG. 14 is an exemplary sequence diagram illustrating a calibration process according to an embodiment.

FIG. 15A is a schematic diagram illustrating an example of a screen displayed by an information processing device in a calibration process according to an embodiment.

FIG. 15B is a schematic diagram illustrating an example of a screen displayed by the information processing device in the calibration process according to the embodiment.

FIG. 15C is a schematic diagram illustrating an example of a screen displayed by the information processing device in the calibration process according to the embodiment.

FIG. 15D is a schematic diagram illustrating an example of a screen displayed by the information processing device in the calibration process according to the embodiment.

FIG. 16 is a graph schematically illustrating a relationship between elapsed time and pedal angle according to pedal operation.

FIG. 17 is a flowchart illustrating an exemplary process during playing a piano by an information processing device according to an embodiment.

FIG. 18 is schematic diagrams each illustrating an example of direct display of an angle according to an attitude of a fastener, according to an embodiment.

FIG. 19 is schematic diagrams each illustrating an example of display of an angle according to an attitude of the fastener by using a bar graph, according to an embodiment.

FIG. 20 is schematic diagrams each illustrating a more specific example of display of an angle by using a bar graph, according to an embodiment.

FIG. 21 is a schematic diagram illustrating an example of an angle display screen showing a temporal change in pedaling angle according to an embodiment.

### DESCRIPTION OF EMBODIMENTS

Embodiments of the present disclosure will be described in detail below with reference to the drawings. Note that in the following embodiments, the same portions are denoted by the same reference numerals, and redundant descriptions thereof are omitted.

Hereinafter, the embodiments of the present disclosure will be described in the following order.
1. About embodiments
   1-1. Configuration according to embodiment
   1-2. Specific example of casing according to embodiment
   1-2-1. Exemplary structure of fastener
   1-2-2. Example of mounting sensor
   1-2-3. Example of mounting casing
1-3. Process according to embodiment
   1-3-1. About calibration
   1-3-2. Process example in information processing device according to embodiment
   1-3-3. Display example in information processing device according to embodiment

### 1. About Embodiments

The embodiments of the present disclosure will be described. In an embodiment of the present disclosure, a casing of a detection device including a sensor detecting an attitude is removable fixed to a pedal for assistance for playing a piano by using a clamp mechanism. Calculating a pedaling angle of the pedal on the basis of an output from the sensor makes it possible to evaluate pedal operation by a player

### 1-1. Configuration According to Embodiment

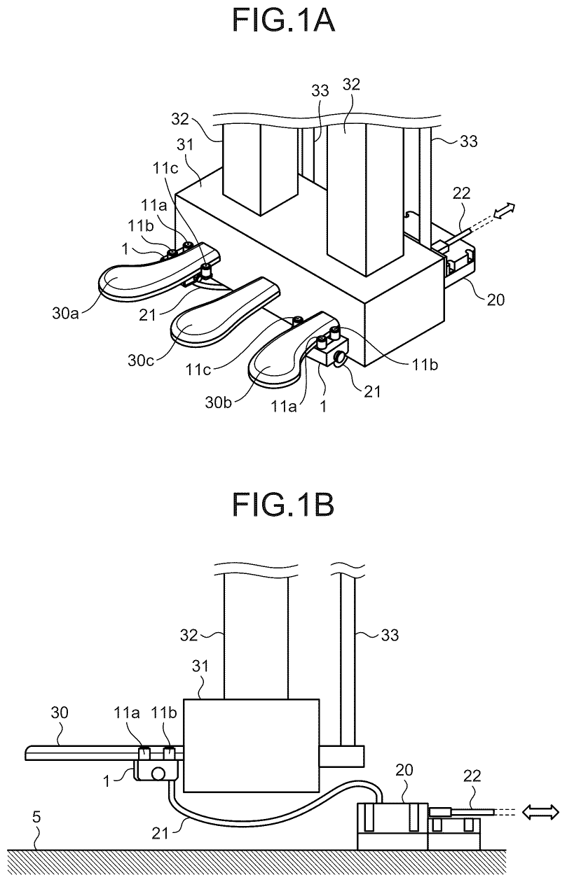

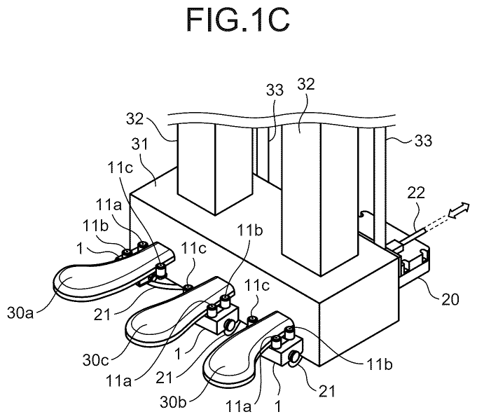

FIGS. 1A, 1B, and 1C are schematic diagrams each illustrating an overview of the detection device according to an embodiment. More specifically, FIGS. 1A and 1C are each an overhead view illustrating the detection device according to the embodiment being installed on the piano. In addition, FIG. 1B is a side view of the detection device being installed on the piano. In FIGS. 1A to 1C, the piano is illustrated as a grand piano.

In FIG. 1A, pedal pillars 32 each having one end fixed to a piano body (not illustrated) have the other ends provided with a pedal box 31. In this example, as illustrated in FIG. 1B, the pedal box 31 is spaced with a certain gap from a floor 5.

The pedal box 31 is provided with three pedals 30a, 30b, and 30c each assisting to play a piano keyboard with the player's foot. Each of the pedals 30a, 30b, and 30c is provided with a pedal rod 33 at a position via a fulcrum (not illustrated) in the pedal box 31. When each of the pedals 30a, 30b, and 30c is pressed, the pedal rod 33 is raised according to the pedaling angle, and pressing motion is transmitted to the piano body.

Note that the pedaling angle is an angle when each of the pedals 30a, 30b, and 30c is pressed where a state in which each of the pedals 30a, 30b, and 30c is not pressed is defined as an angle of 0° with the fulcrum as a vertex.

Here, functions of the pedals 30a, 30b, and 30c will be schematically described.

When, of the pedals 30a, 30b, and 30c, the pedal 30a on the left side is pressed, a device such as a hammer that strikes a string is moved horizontally, and a position where the hammer strikes the string is shifted. In other words, the pedal 30a is a pedal that is pressed to make sound softer as a whole, and is called a soft pedal, a shift pedal, an una corda pedal, or the like.

When, of the pedals 30a, 30b, and 30c, the pedal 30b on the right side is pressed, dampers for suppressing vibration of the strings are simultaneously separated from the strings. In other words, the pedal 30b is a pedal that is pressed to maintain the vibration of the strings as a whole for a long time, and is called a loud pedal, a forte pedal, a sustaining pedal, or the like.

When, of the pedals 30a, 30b, and 30c, the pedal 30c at the center is pressed, only a damper of a key struck does not hit the string. In other words, the pedal 30c is a pedal that is pressed to maintain the vibration of the string of the key struck immediately after the pressing of the pedal for a long time, and is called a sostenuto pedal.

Of the pedals 30a, 30b, and 30c described above, in general, the pedal 30b is operated most frequently, and the pedal 30c is operated least frequently. Furthermore, in the following description, the pedal 30a is appropriately referred to as soft pedal, the pedal 30b is appropriately referred to as loud pedal, and the pedal 30c is appropriately referred to as sostenuto pedal. In addition, when it is not necessary to distinguish the pedals 30a, 30b, and 30c, the pedals 30a, 30b, and 30c are described as pedal 30.

Returning to the description of FIG. 1A, a casing 1 including a sensor and a fastener, which are not illustrated, is fixedly mounted to a pedal 30 by using a clamp mechanism of the fastener. More specifically, the casing 1 is fixedly mounted to the pedal 30 by being held between protrusions 11a and 11b and a protrusion 11c that are provided on the fastener. In the example of FIG. 1A, the casing 1 is mounted to each of the pedals 30a and 30b. For example, in the pedal 30b, the casing 1 is arranged so that two protrusions 11a and 11b are on the right side of the pedal 30b and one protrusion 11c is on the left side of the pedal 30b, and a distance between the protrusions 11a and 11b and the protrusion 11c is reduced to fix the casing 1 to the pedal 30b.

Note that FIG. 1A shows an example, and the present disclosure is not limited to this example. In other words, as illustrated in FIG. 1C, the casing 1 may be mounted to each of the pedals 30a to 30c. Furthermore, the casing 1 may be mounted to only one of the pedals 30a to 30c (e.g., the pedal 30b).

In FIG. 1A, an output from the sensor of each casing 1 (hereinafter, referred to as a sensor output) is transmitted to a signal processing device 20 via a cable 21 connected to each casing 1. The signal processing device 20 adds time information (time stamp) indicating the time at which the sensor output is acquired, to the sensor output from each casing 1 received via the cable 21. The signal processing device 20 may further add an identification signal for identification of the casing 1 related to the sensor output, to the received sensor output from each casing 1.

The signal processing device 20 transmits sensor data in which pieces of information is added to the sensor output, to an information processing device which is not illustrated, via a cable 22. The information processing device performs processing such as calibration of the sensor included in each casing 1, screen presentation based on the sensor output, and the like, on the basis of the sensor data received via the cable 22.

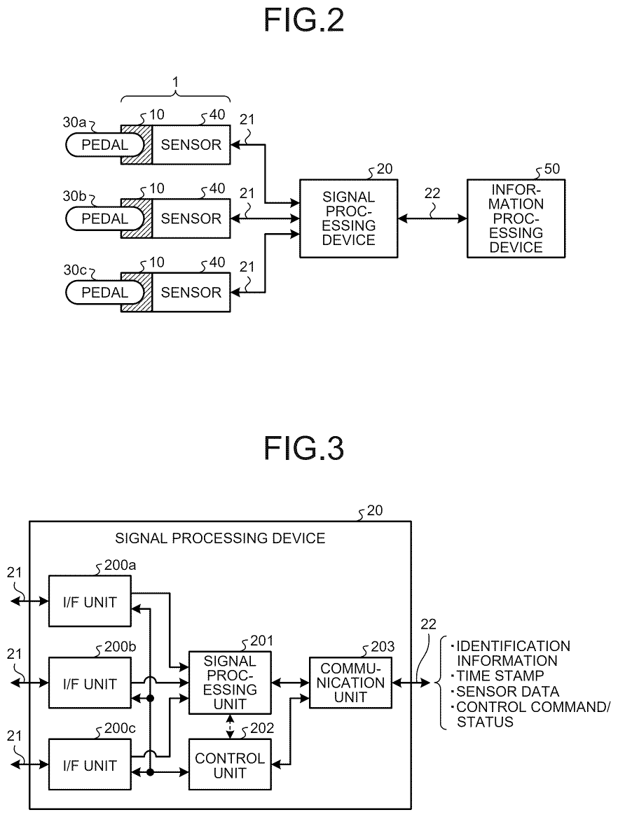

FIG. 2 is a schematic diagram illustrating an exemplary configuration of a detection system according to an embodiment.

In FIG. 2, the detection system includes the casings 1 of the detection devices, the signal processing device 20, and an information processing device 50. Each of the casings 1 includes the fastener 10 and a sensor 40. The fastener 10 is fixedly mounted to each of the pedals 30a, 30b, and 30c by using the clamp mechanism. The sensors 40 are connected to the signal processing device 20 via the cables 21. The signal processing device 20 is connected to the information processing device 50 via the cable 22.

For example, an inertial measurement unit (IMU) including a three-axis gyroscope and a three-directional accelerometer may be applied to the sensor 40. The sensor 40 may further include a geomagnetic sensor. The sensor 40 is fixedly mounted to the casing 1, and outputs a sensor output including an output by the gyroscope, an output by the accelerometer, and an output by the geomagnetic sensor in a case where the geomagnetic sensor is included, for example, as digital data of a predetermined number of bits. On the basis of this sensor output, it is possible to detect an attitude of the casing 1 in a three-dimensional space, for example, an angle relative to each of xyz axes with the origin at the sensor 40.

The signal processing device 20 controls the operation of the sensor 40 of each casing 1 according to an external instruction (e.g., from the information processing device 50). In addition, the signal processing device 20 adds the time information indicating the time at which a result of the detection is acquired and identification information for identification of each casing 1 or each sensor 40, to an output from the sensor 40 of each casing 1. The signal processing device 20 shapes the sensor data in which pieces of information is added to the sensor output from each sensor 40 into a predetermined format, and transmits the sensor data to the information processing device 50 via the cable 22.

The information processing device 50 may generate, for example, a screen indicating a pressing state of each of the pedals 30a to 30c, on the basis of the sensor data transmitted from the signal processing device 20, and present the screen to a user. Furthermore, the information processing device 50 may present, to the user, a user interface (UI) for controlling the operation of each sensor 40 including calibration of each sensor 40, controlling the operation of the signal processing device 20, checking statuses of each sensor 40 and signal processing device 20, and the like.

FIG. 3 is a functional block diagram illustrating

exemplary functions of the signal processing device 20 according to an embodiment.

In FIG. 3, the signal processing device 20 includes interface (I/F) units 200a, 200b, and 200c, a signal processing unit 201, a control unit 202, and a communication unit 203.

The I/F units 200a, 200b, and 200c, the signal processing unit 201, the control unit 202, and the communication unit 203 may be implemented by executing a predetermined program on a processor such as a central processing unit (CPU). The present disclosure is not limited thereto, and some or all of the interface (I/F) units 200a, 200b, and 200c, and the signal processing unit 201, the control unit 202, and the communication unit 203 may be implemented by hardware circuits that operate in cooperation with each other.

The I/F units 200a, 200b, and 200c are each an interface that receives the sensor output from each sensor 40. The sensor outputs received by the I/F units 200a, 200b, and 200c are passed to the signal processing unit 201.

Here, the I/F units 200a, 200b, and 200c may be associated with the pedals 30a, 30b, and 30c, respectively. For example, it is assumed that the I/F unit 200a receives the output from the sensor 40 of the casing 1 mounted to the pedal 30a. Similarly, it is assumed that the I/F units 200b and 200c receive outputs from the sensors 40 of the casings 1 that are mounted to the pedals 30b and 30c, respectively.

The signal processing unit 201 adds

identification information for identifying the I/F unit 200a, for example, to the sensor output passed from the I/F unit 200a. The present disclosure is not limited thereto, and the I/F unit 200a may add the identification information for identifying itself to the sensor output and pass the sensor output to the signal processing unit 201. When the casing 1 including the sensor 40 that passes the sensor output to the I/F unit 200a is mounted to the pedal 30a as assumed, the signal processing unit 201 can perform the processing assuming that the sensor output passed from the I/F unit 200a is a sensor output according to the pedaling angle of the pedal 30a.

The signal processing unit 201 adds, for example, time information (time stamp) indicating the time at which the sensor output is passed and identification information for identification of each of the I/F units 200a, 200b, and 200c, to the sensor output passed from each of the I/F units 200a, 200b, and 200c. The signal processing unit 201 passes the sensor data in which the time information and the identification information are added to the sensor output, to the communication unit 203.

The communication unit 203 communicates with the information processing device 50 via the cable 22. For example, a universal serial bus (USB) may be applied as a communication system by which the communication unit 203 communicates with the information processing device 50. Furthermore, here, it is described that the communication unit 203 communicates with, but is not limited to, the information processing device 50 by wired communication via the cable 22. For example, the communication unit 203 may communicate with the information processing device 50 by short-range wireless communication such as Bluetooth (registered trademark).

The control unit 202 controls the operation of the entire signal processing device 20. Furthermore, the control unit 202 may control the operation of each sensor 40 via each of the I/F units 200a, 200b, and 200c according to a control command received from the information processing device 50 via the communication unit 203, for example. Furthermore, the control unit 202 may transmit status information indicating a state of each sensor 40 and status information indicating a state of the signal processing unit 201, which are received from each sensor 40 via each of the I/F units 200a, 200b, and 200c, to the information processing device 50 via the communication unit 203.

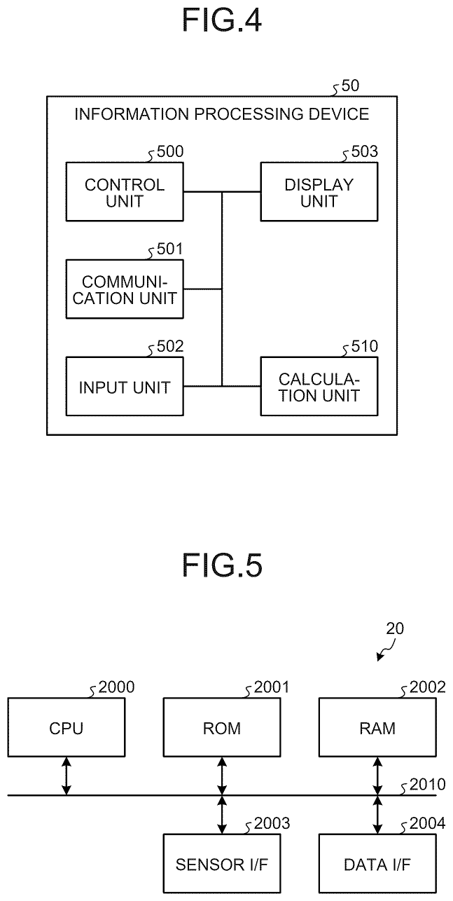

FIG. 4 is a functional block diagram illustrating exemplary functions of the information processing device 50 according to an embodiment.

In FIG. 4, the information processing device 50 includes a control unit 500, a communication unit 501, an input unit 502, a display unit 503, and a calculation unit 510. The control unit 500, the communication unit 501, the input unit 502, the display unit 503, and the calculation unit 510 may be implemented by executing a predetermined program on a CPU. The present disclosure is not limited thereto, and some or all of the control unit 500, the communication unit 501, the input unit 502, the display unit 503, and the calculation unit 510 may be implemented by hardware circuits that operate in cooperation with each other.

The control unit 500 controls the operation of the entire information processing device 50. The communication unit 501 performs communication between the information processing device and an external device. For example, the communication unit 501 communicates with the signal processing device 20 via the cable 22.

The input unit 502 receives an input corresponding to a user operation on a pointing device such as a mouse or a touch pad, or an input device such as a keyboard. The display unit 503 generates display control information for displaying a screen on a display device. Furthermore, the input unit 502 and the display unit 503 may constitute a user interface (UI) for controlling the operation of the entire detection system including the signal processing device 20 and the sensors 40.

The calculation unit 510 calculates the pedaling angle of each of the pedals 30a, 30b, and 30c on the basis of the sensor data transmitted from the signal processing device 20. For example, the display unit 503 may generate the display control information for displaying, to the user, a screen indicating a state of each of the pedals 30a, 30b, and 30c, on the basis of the calculated pedaling angle. Furthermore, the calculation unit 510 may give an instruction for calibration of each sensor output output from each sensor 40, to the signal processing device 20, for example, according to the user operation on the input unit 502 based on the display on the display unit 503.

FIG. 5 is a block diagram illustrating an exemplary hardware configuration of a signal processing device 20 applicable to an embodiment.

In FIG. 5, the signal processing device 20 includes a CPU 2000, a read only memory (ROM) 2001, a random access memory (RAM) 2002, a sensor I/F 2003, and a data I/F 2004 that are communicably connected to each other by a bus 2010.

The CPU 2000 uses the RAM 2002 as a work memory to operate according to a program stored in the ROM 2001, and controls the operation of the entire signal processing device 20. The sensor I/F 2003 is an interface for each sensor 40, and may have, for example, a connection unit for connecting each sensor 40, for each sensor 40. The sensor I/F 2003 controls communication with each sensor 40 according to the control of each of the I/F units 200a, 200b, and 200c described above.

The data I/F 2004 corresponds to, for example, a USB, and communicates with the information processing device 50 via the cable 22 under the control of the communication unit 203 described above.

In the signal processing device 20, upon execution of a program for the signal processing device 20 according to an embodiment, the CPU 2000 configures each of the above-described I/F units 200a, 200b, and 200c, and signal processing unit 201, control unit 202, and communication unit 203 as, for example, a module on a main storage area in the RAM 2002.

The program is stored, for example, in the ROM 2001 in advance. The present disclosure is not limited thereto, and the program may be supplied, for example, from the information processing device 50 to the signal processing device 20 via the cable 22 by communication via the data I/F 2004. Furthermore, the program may be provided by being stored in a removable storage medium such as a compact disk (CD), a digital versatile disk (DVD), or a universal serial bus (USB) memory.

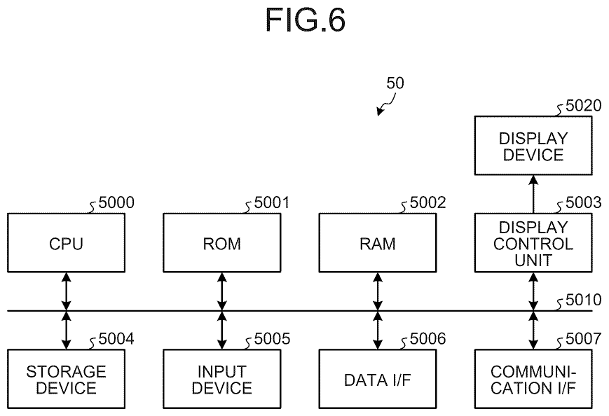

FIG. 6 is a block diagram illustrating an exemplary hardware configuration of the information processing device 50 applicable to an embodiment.

In FIG. 6, the information processing device 50 includes a CPU 5000, a ROM 5001, a RAM 5002, a display control unit 5003, a storage device 5004, an input device 5005, a data I/F 5006, and a communication I/F 5007 that are communicably connected to each other by a bus 5010.

In this way, the information processing device 50 may have a configuration of a general computer. A general personal computer, or a smartphone or tablet computer may be applied to the information processing device 50.

The storage device 5004 is a non-volatile storage medium, such as a hard disk drive or a flash memory. The CPU 5000 uses the RAM 5002 as a work memory to operate according to a program stored in the storage device 5004 and the ROM 5001, and controls the processing of the entire information processing device 50.

The display control unit 5003 generates a display signal compatible with a display device 5020, on the basis of the display control information generated by the CPU 5000. The display device 5020 includes a display element and a drive circuit for driving the display element, and displays a screen according to the display signal passed from the display control unit 5003. This configuration makes it possible to present a screen corresponding to the display control information generated by the CPU 5000.

The input device 5005 outputs a control signal according to the user operation. The input device 5005 may be connected to the data I/F 5006 described later. The input device 5005 may include a pointing device such as a mouse or a touch pad, and a keyboard. The present disclosure is not limited thereto, and, for example, a touch pad that outputs a control signal according to a contact position upon the user operation may be applied to the input device 5005. Furthermore, the input device 5005 and the display device 5020 may be integrally formed so that the input device 5005 can be viewed through the display device 5020 to constitute a so-called touch pad.

The data I/F 5006 is an interface for transmitting and receiving data to and from an external device. For example, a USB may be applied to the data I/F 5006. The transmission and reception of data to and from the signal processing device 20 via the cable 22 may be performed, for example, by the data I/F 5006.

The communication I/F 5007 controls communication via a network such as the Internet or a local area network (LAN).

In the information processing device 50, upon execution of an information processing program according to an embodiment, the CPU 5000 configures each of the above-described control unit 500, communication unit 501, input unit 502, display unit 503, and calculation unit 510 as, for example, a module on a main storage area in the RAM 5002.

The information processing program may be supplied to the information processing device 50 via the network such as the Internet, for example, by communication via the communication I/F 5007. Furthermore, the information processing program may be provided by being stored in a removable storage medium such as a CD, DVD, or USB memory.

### 1-2. Specific Example of Casing According to Embodiment

Next, a configuration of the casing 1 according to an embodiment will be described more specifically.

### 1-2-1. Exemplary Structure of Fastener

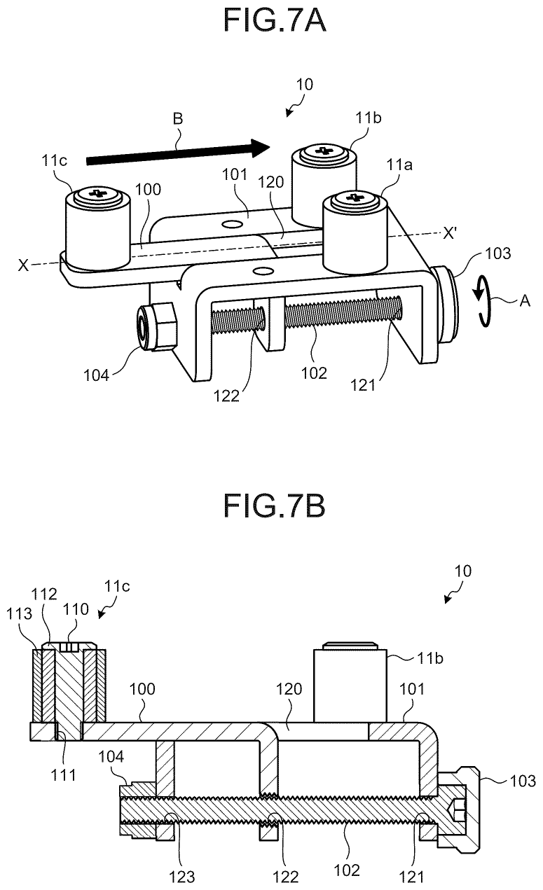

First, an exemplary structure of the fastener 10 according to an embodiment will be described. FIGS. 7A and 7B are schematic diagrams illustrating an exemplary structure of the fastener 10 according to an embodiment. FIG. 7A is an overhead view of the fastener 10. FIG. 7B is a cross-sectional view taken along line x-x′ of FIG. 7A. Note that in FIGS. 7A and 7B, the fastener 10 has an upper surface on the upper side and a lower surface on the lower side.

In the example of FIG. 7A, the fastener 10 includes a first member 100, a second member 101, and a bolt 102 coupling the first member 100 and the second member. The first member 100 has an I-shape (rectangle) as viewed from above in the drawing. Meanwhile, the second member 101 has a U-shape in which a cutout is provided from the center of one side of a rectangle along a side in contact with the one side.

The first member 100 is configured to be held in a cutout portion of the second member 101, and is movable along a side 120 of the cutout portion of the second member 101. In other words, the second member 101 is movably combined with the first member 100 along a side connecting a first end portion of a short side of the first member 100 and an opposite end portion to the first end portion. In addition, the first member 100 and the second member 101 are configured so that upper surfaces thereof are flush with each other.

As illustrated in FIGS. 7A and 7B, the first member 100 is bent vertically toward the lower surface side at an end positioned in the cutout portion of the second member 101. In addition, the second member 101 is bent in vertically toward the lower surface side, at an end in which the cutout portion is provided and at an end opposite to the end. Note that each of the ends of the first member 100 and the second member 101 is not limited to a bent structure, and may be constituted by coupling another member.

In the first member 100 and the second member 101, the bent portions are respectively provided with a hole portion 122 and hole portions 121 and 123, each corresponding to the bolt 102. Of the hole portions 121, 122, and 123, at least the hole portion 122 is provided with threads corresponding to the bolt 102. In the example of the drawings, the bolt 102 is inserted from the hole portion 121 through the hole portions 121, 122, and 123, and an end is fixed with a nut 104.

For the bolt 102, at least a bolt is used that has a thread portion having a length extending from an insertion portion of the hole portion 121 to the vicinity of an insertion portion of the hole portion 123. The length of the bolt 102 is preferably determined according to a permitted movable range of the first member 100. Furthermore, the nut 104 can be omitted.

The bolt 102 has a head portion that is rotated clockwise, for example, as indicated by an arrow A in FIG. 7A with the head portion of the bolt 102 in contact with the bent portion of the second member 101. The bolt 102 converts this rotational movement into linear movement of the bolt 102 in a screw axis direction. By the linear movement of the bolt 102, the first member 100 moves to an end side of the second member 101 where the hole portion 121, which is an insertion hole for the bolt 102, is provided, as indicated by an arrow B in FIG. 7A, along the threads provided in the hole portion 122 and on the bolt 102.

Note that the nut 104 can be omitted. Furthermore, in the illustrated example, a knob 103 is mounted to the head portion of the bolt 102 to facilitate rotation of the bolt 102.

In addition, the first member 100 is provided with the protrusion 11c at an opposite end portion to the bent portion. Meanwhile, the second member 101 has an end portion that is provided with the hole portion 121 as the insertion hole for the bolt 102, that is, an end portion that is opposed to the protrusion 11c when combined with the first member 100, and the end portion is provided with the protrusions 11a and 11b as second protrusions. In other words, the protrusions 11a and 11b are provided at a portion near a first side and a portion near a second side, of the first side and the second side connecting an end portion on a side where the protrusion 11c of the first member 100 is provided and an opposite end portion to the end portion.

Furthermore, for example, as illustrated as a cross-section in FIG. 7B, the protrusion 11c includes a first cylindrical member 112 and a second cylindrical member 113 making close contact with the outer periphery of the first cylindrical member 112. The protrusion 11c is mounted into a screw hole 111 provided at the end portion of the first member 100, by a screw 110 penetrating the center of the first cylindrical member 112. The protrusions 11a and 11b each have a configuration similar to that of the protrusion 11c, and therefore, the descriptions thereof are omitted here.

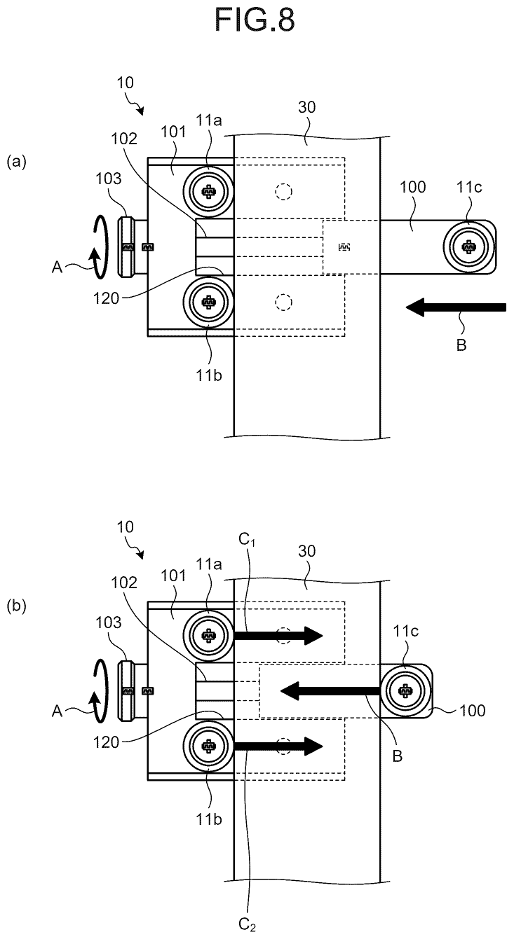

FIG. 8 is schematic diagrams each illustrating an action of the fastener 10 according to an embodiment. Sections (a) and (b) of FIG. 8 each illustrate an example in which the fastener 10 is viewed from the upper surface side. In this way, the protrusions 11a and 11b are arranged at positions corresponding to vertices of a base of an isosceles triangle having the protrusion 11c as a vertex.

First, as illustrated in the section (a) of FIG. 8, a distance between the protrusions 11a and 11b and the protrusion 11c of the fastener 10 is adjusted to be larger than a width of a portion of the pedal 30 to which the fastener 10 (casing 1) is mounted. Then, the fastener 10 is held so that the pedal 30 is held between the protrusions 11a and 11b and the protrusion 11c of the fastener 10. In this drawing, one side surface of the pedal 30 abuts on the protrusions 11a and 11b, and the protrusion 11c is separated from the other side surface of the pedal 30 opposite to the one side surface of the pedal 30. In this state, the bolt 102 is rotated in a direction in which the screw is tightened, that is, in a direction in which the protrusion 11c is moved toward the protrusions 11a and 11b (indicated by an arrow A in the drawing).

The section (b) of FIG. 8 illustrates a state where the bolt 102 is rotated from the state of the section (a) to bring the protrusion 11c into abutment on the other side surface of the pedal 30. In this state, further rotating and tightening the bolt 102 in the direction indicated by the arrow A generates a holding force to hold the pedal 30, by a force, indicated by an arrow B, generated by the protrusion 11c, and forces, indicated by arrows C₁ and C₂, generated as reaction to the force indicated by the arrow B by the protrusions 11a and 11b, as illustrated in the drawing. The fastener 10 (casing 1) is fixedly mounted to the pedal 30 by this holding force.

In this way, the hole portions 121 and 122 and the bolt 102 penetrating the hole portions 121 and 122 constitute an adjustment unit that adjusts the distance between the protrusions 11a and 11b (second protrusions) and the protrusion 11c (first protrusion). The fastener 10 is fixedly mounted to the pedal 30 by holding the pedal 30 by adjusting the distance between the protrusions 11a and 11b and the protrusion 11c by the rotation of the bolt 102. Therefore, the fastener 10 is removably mounted to the pedal 30.

Note that in the above description, the bolt 102, the hole portions 121 and 122, and the protrusions 11a, 11b, and 11c are used to generate the holding force to the pedal 30. but the present disclosure is not limited to this example. For example, the holding force to the pedal 30 is not limited to the rotational movement of the bolt 102, and may be generated by a mechanism using a spring or a lever.

In addition, in the above description, the pedal 30 is held between three points of the protrusion 11c and the protrusions 11a and 11b corresponding to the respective vertexes of the base of the isosceles having the protrusion 11c as the vertex, but the present disclosure is not limited to this example. For example, the pedal 30 may be held and fixed between two points. However, the holding between two points, the fastener 10 (casing 1) may rotate in a direction perpendicular to a holding direction. Therefore, in terms of stability, a structure of holding between three points is advantageous to a structure of holding between two points. Note that a structure in which the pedal 30 is held at four points, that is, held at two points on either side is also conceivable. However, in a structure of holding between four points, for example, when a place of the pedal 30 where the fastener 10 is mounted has an asymmetric curve when viewed from above, stable fixing is made difficult undesirably.

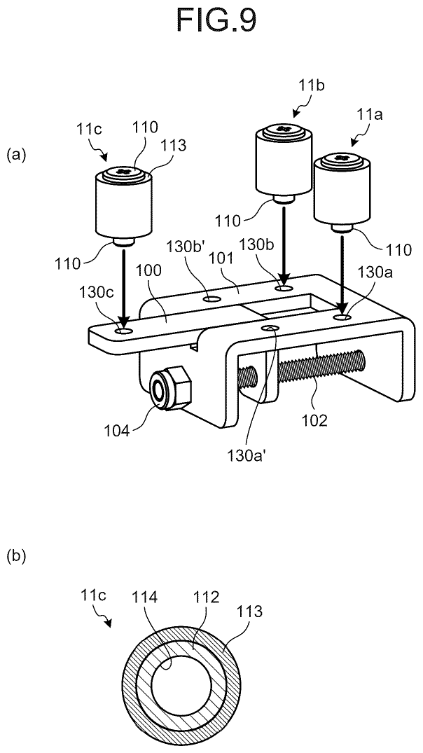

FIG. 9 is schematic diagrams illustrating an exemplary structure of the protrusions 11a, 11b, and 11c according to an embodiment. As illustrated in the section (a) of FIG. 9, in the embodiment, each of the protrusions 11a, 11b, and 11c is removably provided at the fastener 10. In this example, for example, the protrusion 11c is fixed into a screw hole 130c provided in the first member 100, by the screw 110 penetrating the protrusion 11c. Similarly, the protrusions 110a and 110b are fixed into screw holes 130a and 130b provided in the second member 101, by the screws 110 penetrating the protrusions 11a and 11b, respectively.

In this way, the protrusions 11a, 11b, and 11c are removably fixed to the fastener 10 by the screws 110, enabling replacement of the protrusions 11a, 11b, and 11c. For example, preparing a set of the protrusions 11a, 11b, and 11c having a certain height, a set of the protrusions 11a, 11b, and 11c having a height different from the certain height, a set of the protrusions 11a, 11b, and 11c having further different height, . . . , enables correspondence to the pedals 30 having various thicknesses or shapes.

In addition, in the example of the section (a) of FIG. 9, screw holes 130a′ and 130b′ are further provided between the screw holes 130a and 130b and a side of the second member 101 opposed to the screw holes 130a and 130b. Mounting the protrusions 11a and 11b into the screw holes 130a′ and 130b′ makes it possible to fix the pedal 30 having a smaller width, as compared with mounting the protrusions 11a and 11b into the screw holes 130a and 130b.

The section (b) of FIG. 9 is a top view of the protrusion 11c. In this example, the inside of the first cylindrical member 112 has a cavity 114, enabling penetration of the screw 110. The second cylindrical member 113 is provided in close contact with the outer periphery of the first cylindrical member 112. The first cylindrical member 112 may be formed by using, for example, a hard resin such as DURACON (registered trademark). Meanwhile, the second cylindrical member 113 may be formed by using a soft resin such as silicone rubber. The same structure as that of the protrusion 11c is applied to the protrusion 11a and 11b, and the descriptions of the protrusion 11a and 11b are omitted here. A plurality of sets of the protrusions 11a, 11b, and 11c including the second cylindrical members 113 formed of different materials may be prepared.

The shape of each of the protrusions 11a, 11b, and 11c is not limited to the cylindrical shape. In other words, the protrusions 11a, 11b, and 11c preferably have shapes that are perpendicular to the upper surfaces of the first member 100 and the second member 101 when mounted to the first member 100 and the second member 101 and whose surfaces abutting on the pedal 30 have curved surfaces when viewed from the upper surface side. For such shapes, an elliptical cylinder and a semicylinder can be considered.

Note that in the above description, the protrusions 11a to 11c are removably provided for the first member 100 and the second member 101, but the present disclosure is not limited to this example. For example, some or all of the protrusions 11a to 11c may be integrally formed with the first member 100 and the second member 101.

### 1-2-2. Example of Mounting Sensor

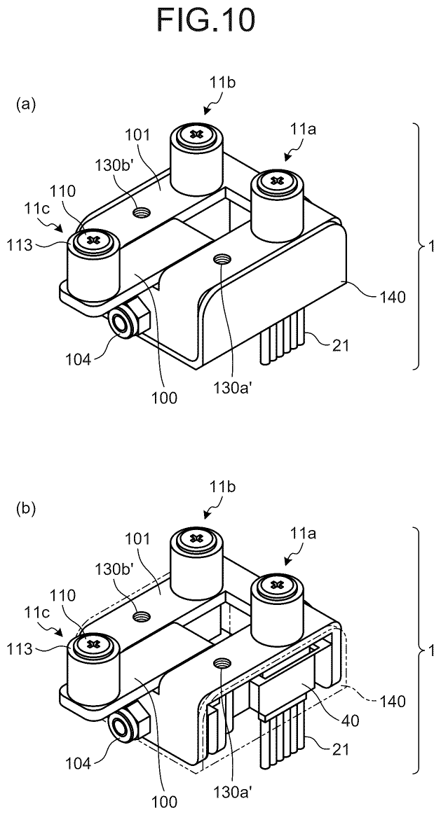

Next, an example of mounting the sensor 40 to the casing 1, according to the embodiment will be described. FIG. 10 is schematic diagrams each illustrating mounting of the sensor 40 on the casing 1 according to an embodiment. Each of the sections (a) and (b) of FIG. 10 is an overhead view of the casing 1 according to the embodiment.

In the example of the section (a) of FIG. 10, a portion in which the bolt 102 and the like are stored is covered with a cover 140, in the casing 1. The cover 140 is fixedly mounted to the casing 1. The cable 21 is drawn from a bottom surface of the casing 1.

The section (b) of FIG. 10 transparently illustrates the cover 140 in the state of the section (a). In the example of the section (b), the sensor 40 is fixedly mounted to the cover 140 toward the inside of the casing 1. A position and method of mounting the sensor 40 are not limited to this example. In other words, the sensor 40 may be mounted to the casing 1 at another position or by another method, as long as the position or attitude of the sensor 40 is fixed relative to the casing 1.

The cable 21 is directly connected to the sensor 40, and the sensor outputs from the sensor 40 are transmitted to the outside of the casing 1 via the cable 21. Note that the outputs from the sensor 40 are normalized by calibration, which is described later, and therefore, the position, angle, and attitude at which the sensor 40 is mounted to the casing 1 are not particularly limited.

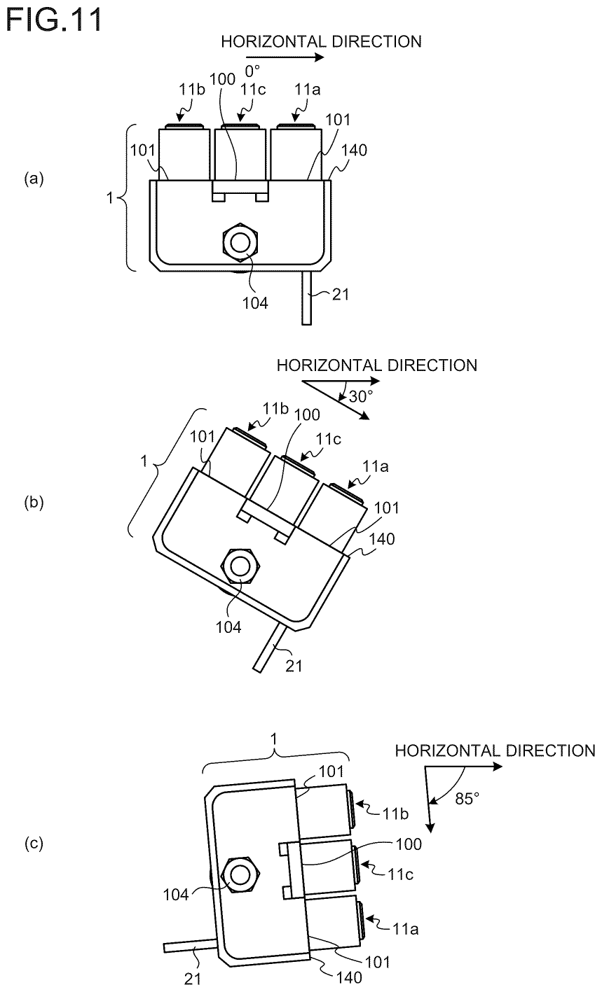

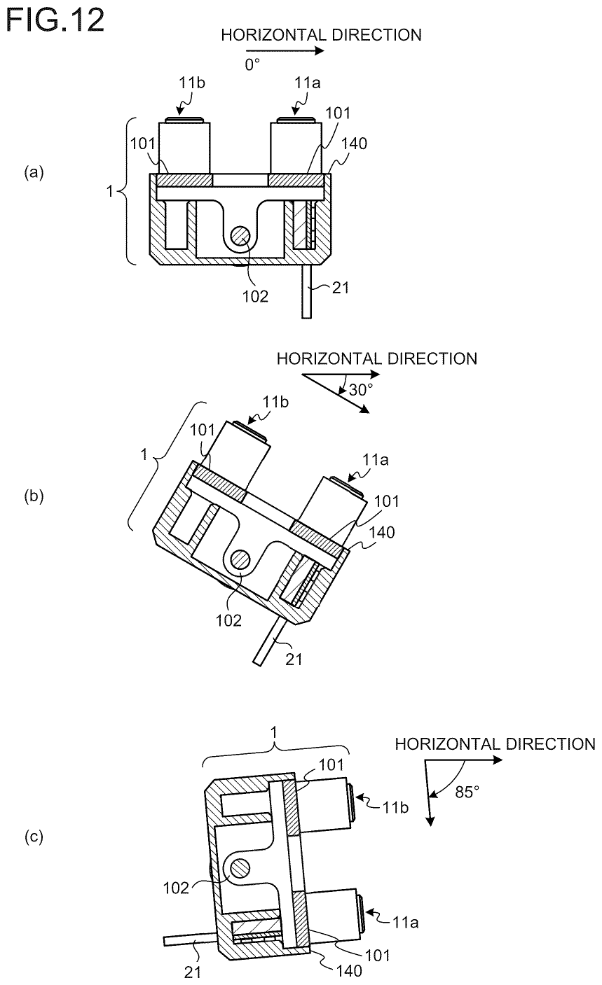

FIGS. 11 and 12 are schematic diagrams each illustrating a state in which the casing 1 according to an embodiment is inclined. The sections (a) to (c) of FIG. 11 are views of the casing 1 as viewed from the side of the nut 104, and the sections (a) to (c) of FIG. 12 are cross-sectional views taken along a plane between the protrusions 11a and 11b and the protrusion 11c of the casing 1 when the casing 1 is viewed from the side of the nut 104.

FIGS. 11 and 12 each illustrate a state in which the casing 1 is inclined in a direction of mounting the pedal 30, that is, in a direction in which the pedal 30 penetrates between the protrusions 11a and 11b and the protrusion 11c. More specifically, the sections (a) to (c) of FIGS. 11 and 12 schematically illustrate how inclination (inclination angle) of the casing 1 mounted to the pedal 30 changes according to the pedaling angle of the pedal 30.

Here, it is assumed that the angle of the casing 1 is 0° when the upper surfaces of the first member 100 and the second member 101 are parallel with a horizontal plane in a direction in which the pedal 30 penetrates between the protrusions 11a and 11b and the protrusion 11c. It is assumed that the angle of the casing 1 increases, for example, when the casing 1 is pressed downward on the basis of a fulcrum of the pedal 30 on which the casing 1 is mounted. In the examples of FIGS. 11 and 12, the angles of the casing 1 is 0° in the section (a), 15° in the section (b), and 85° in the section (c).

As illustrated in the sections (a) to (c) of FIG. 12, the sensor 40 is fixedly mounted to the cover 140, and the attitude of the sensor 40 relative to the casing 1 does not change. Therefore, the sensor 40 has an attitude according to the inclination of the casing 1, and can detect the attitude of the casing 1.

Note that in practice, it is considered that the pedal 30 will not be pressed to the angle indicated by the sections (c) of FIGS. 11 and 12. However, depending on a mounting state of the casing 1 to the pedal 30, the casing 1 may be inclined to the angle illustrated in the sections (c) of FIGS. 11 and 12.

### 1-2-3. Example of Mounting Casing

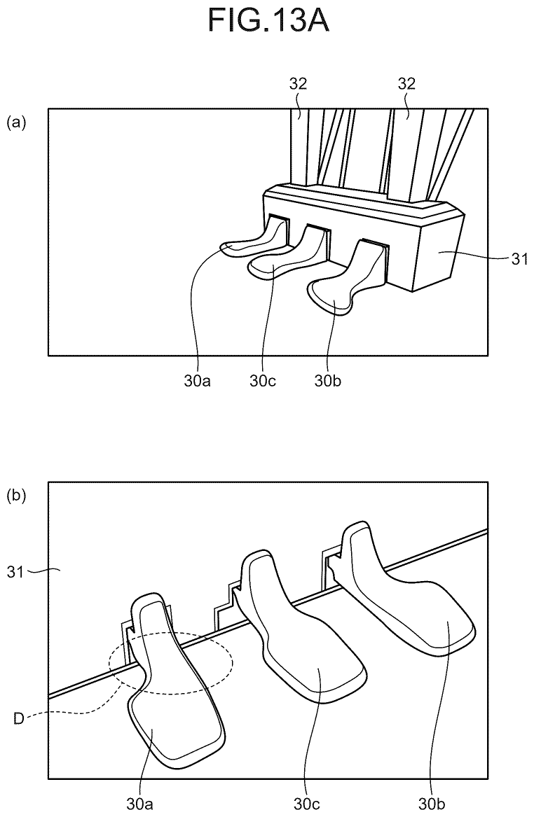

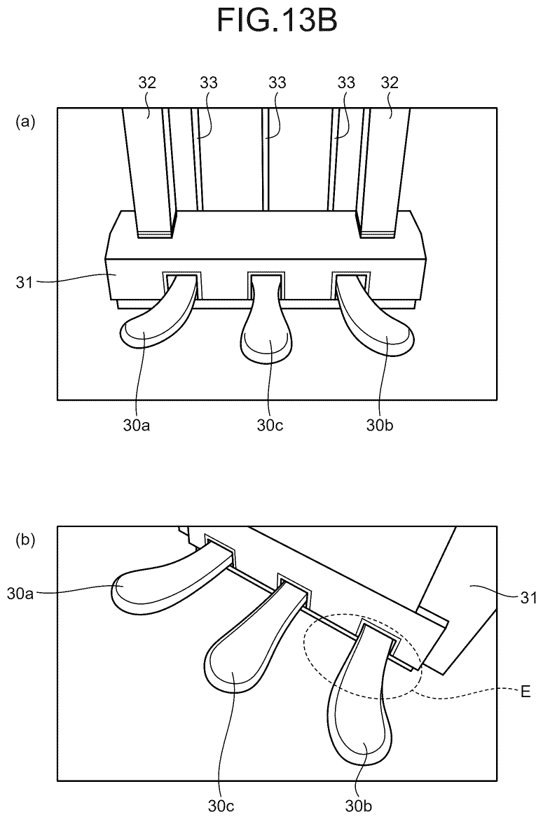

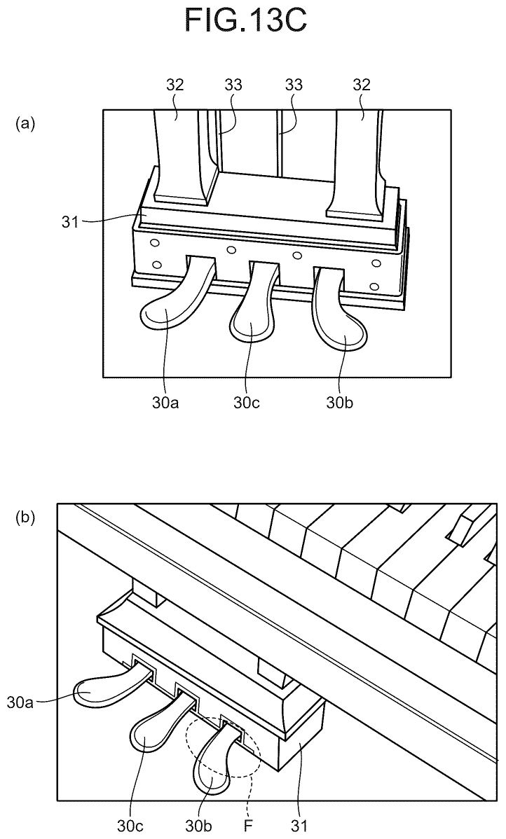

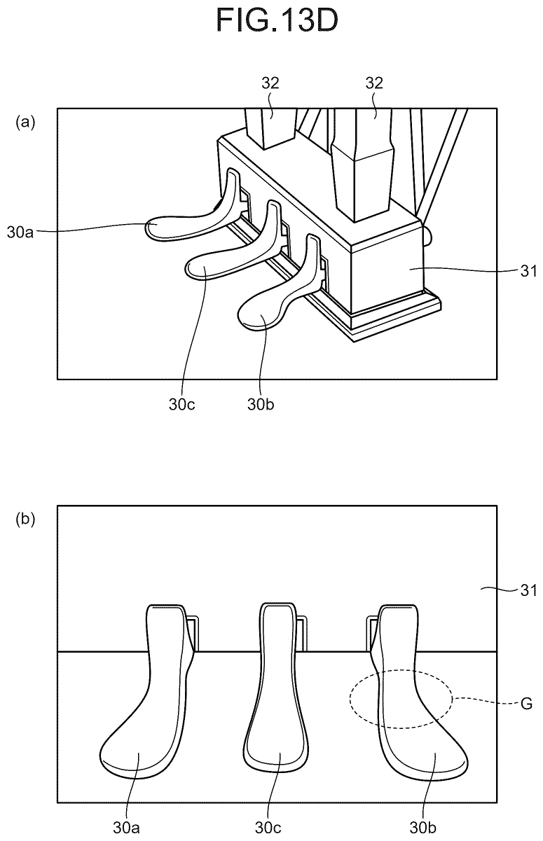

Next, mounting of the casing 1 to various pedals 30 will be described. Here, description will be given, focusing on the fastener 10 included in the casing 1. FIGS. 13A to 13D are schematic diagrams illustrating examples of the pedals 30 having different shapes. In FIGS. 13A to 13D, the section (a) is a view including the entire pedal box 31, and the section (b) is a view focusing on the shapes of the pedals 30a, 30b, and 30c.

FIG. 13A illustrates an example in which the pedals 30a to 30c have widths parallel from the roots (the openings of the pedal box 31) to predetermined positions, and suddenly increase from the predetermined positions. Furthermore, each of the pedals 30a to 30c has a structure curved upward at the root. In such a configuration, the fastener 10 (casing 1) may be mounted, from below, to a position near the root indicated within a range D in the section (b) of FIG. 13A. The fastener 10 has a structure configured to be mounted on one side of a target by the protrusions 11a to 11c, and each of the protrusions 11a to 11c is replaceable. Therefore, the fastener 10 is allowed to be mounted to the pedal 30 even when the pedal 30 includes an upward curved structure within the range D.

FIG. 13B illustrates an example in which the pedals 30a to 30c are curved from root portions when viewed from the upper surface side. In such a configuration, the fastener 10 (casing 1) may be mounted, from below, to a position near the root indicated within a range E in the section (b) of FIG. 13B. The fastener 10 is mounted to the pedal 30 at three points by the protrusions 11a to 11c, and therefore, the fastener 10 is allowed to be mounted to the pedal 30 even when the portion of the pedal 30 to which the fastener 10 is mounted includes a curved portion when viewed from the upper surface side.

FIG. 13C illustrates an example in which the pedals 30a to 30c are horizontal at the root portions and are substantially constant from the root portions to predetermined positions in width. In such a configuration, the fastener 10 (casing 1) may be mounted, from below, to a position near the root indicated within a range F in the section (b) of FIG. 13C.

FIG. 13D illustrates an example in which the pedals 30a to 30c are substantially constant from the root portions to predetermined positions in width. In the example of FIG. 13D, the width of each of the pedals 30a to 30c is smaller near the root thereof than that in the example of FIG. 13C described above. Furthermore, each of the pedals 30a to 30c has a structure curved upward at the root. In such a configuration, the fastener 10 (casing 1) may be mounted, from below, to a position near the root indicated within a range G in the section (b) of FIG. 13D.

The fastener 10 has a structure configured to be mounted on one side of a target by the protrusions 11a to 11c, and each of the protrusions 11a to 11c is replaceable. Therefore, the fastener 10 is allowed to be mounted to the pedal 30 even when the pedal 30 includes an upward curved structure within the range D. Furthermore, the positions of the protrusions 11a and 11b are changeable, and therefore, the fastener 10 is allowed to be mounted to the pedal 30 even when the width of the portion of the pedal 30 to which the fastener 10 is mounted is small.

In this way, the casing 1 including the fastener 10 and the sensor 40 according to the embodiment includes the sensor 40 that detects the attitude of the casing 1, the protrusions 11a and 11b and the protrusion 11c holds the pedal 30, and the casing is fixedly mounted to the pedal 30. Therefore, the configuration according to the embodiment has higher versatility than that of the configuration described in Patent Literature 1 in which the displacement sensor to measure the pedaling amount is mounted to the pedal rod, and detection of the pedaling amount (pedaling angle) of the pedal 30 for assistance for playing the piano is further facilitated.

### 1-3. Process According to Embodiment

Next, signal processing using the fastener 10 (casing 1) according to an embodiment will be described.

### 1-3-1. About Calibration

The pedals 30 differ in pedaling amount and angle depending on piano manufacturers or the like. Furthermore, as described with reference to FIGS. 13A to 13D, the pedals 30 have various shapes, and a mounted state of the casing 1 including the sensor 40 and the fastener 10 differs according to each shape. In addition, a manner of mounting the casing 1 to the pedal 30 may be different between the users, and also in this case, there is a possibility that the mounted state of the casing 1 to the pedal 30 is different.

Therefore, when the casing 1 including the sensor 40 and the fastener 10 is mounted to the pedal 30, it is necessary to perform calibration on the basis of the output from the sensor 40 to handle normalized information. In the embodiment, the calibration is performed on the basis of the attitude of the casing 1 in a state where the pedal 30 is not pressed and the attitude of the casing 1 in a state where the pedal 30 is fully pressed, which are acquired during the operation of slowly pressing the pedal 30 with the casing 1 mounted. On the basis of the outputs from the sensor 40 acquired in these states, a coefficient for normalizing the output from the sensor 40 is obtained and held.

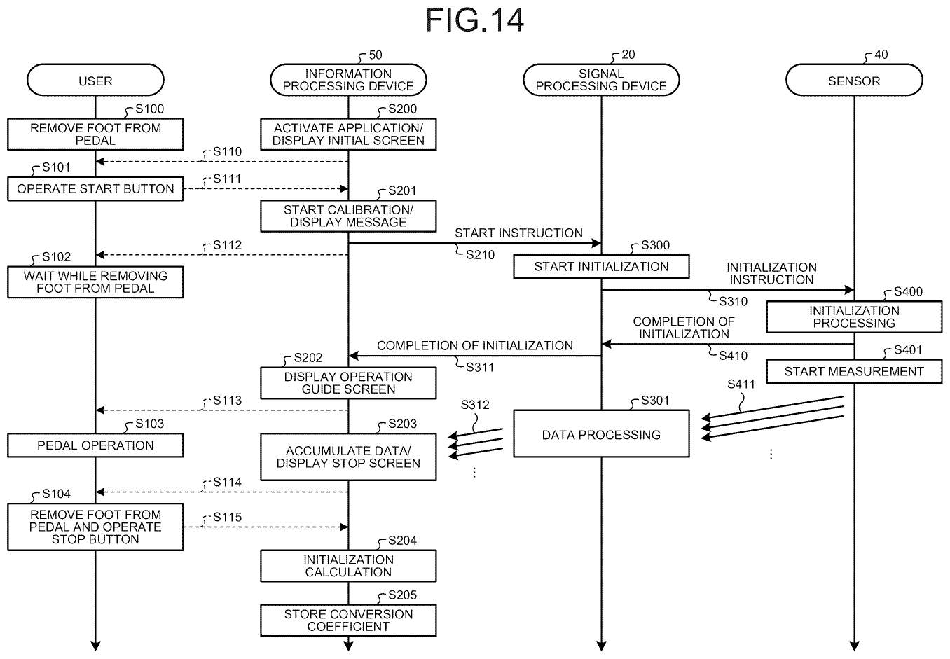

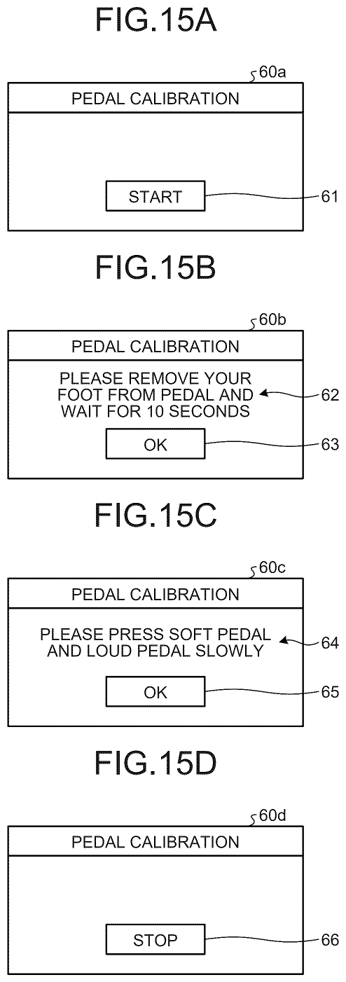

FIG. 14 is an exemplary sequence diagram illustrating a calibration process according to an embodiment. Furthermore, FIGS. 15A to 15D are schematic diagrams each illustrating an example of a screen displayed by the information processing device 50 in the calibration process according to an embodiment. Here, description will be given assuming that the casing 1 is mounted to each of the pedals 30a and 30b by the fastener 10.

In Step S100, the user removes his/her foot from the pedals 30a and 30b, that is, does not press the pedals 30a and 30b. Furthermore, in Step S200, the information processing device 50 activates the information processing program (described as “application” in FIG. 14) according to the embodiment in response to, for example, the user operation. When the information processing program is activated, the information processing device 50 causes the display device 5020 to display an initial screen for pedal calibration according to the activated information processing program (Step S110).

Hereinafter, causing the display device 5020 to display a screen by the information processing device 50 by using the information processing program will be described as “the screen is caused to be displayed by the information processing device” or the like.

FIG. 15A is a schematic diagram illustrating an example of the initial screen displayed by the information processing device 50. In FIG. 15A, the initial screen 60a is provided with a START button 61 for giving an instruction for starting the calibration process.

The user operates the START button 61 on the initial screen 60a (Step S101). In response to this operation (Step S111), the information processing device 50 starts a calibration operation and causes a standby message screen for instructing the user to wait to be displayed (Step S201).

FIG. 15B is a schematic diagram illustrating an example of the standby message screen displayed by the information processing device 50. In FIG. 15B, on the standby message screen 60b, a message 62 instructing the user to wait for a predetermined time (10 seconds in this example) is displayed, and a button 63 indicating acceptance of the message 62 is provided. The information processing device 50 may display, for example, a blank screen according to operation on the button 63. Furthermore, even when the button 63 is not operated, the information processing device 50 may close the standby message screen 60b according to the next screen display.

In response to the display of the standby message screen 60b (Step S112), the user waits while removing his/her foot from the pedals 30a and 30b (Step S102).

In response to the start of the calibration operation in Step S201, the information processing device 50 transmits a start instruction to start the calibration to the signal processing device 20 (Step S210). In response to this start instruction, the signal processing device 20 starts initialization of each sensor 40 (Step S300), and transmits an initialization instruction to the sensor 40 (Step S310). The sensor 40 performs initialization processing according to the initialization processing transmitted from the signal processing device 20 (Step S400).

When the initialization processing is completed, the sensor 40 notifies the signal processing device 20 of the completion of initialization (Step S410). The signal processing device 20 transmits the notification of the completion of initialization, to the information processing device 50 (Step S311).

In response to the notification of the completion of initialization from the signal processing device 20, the information processing device 50 causes an operation guide screen for showing operation related to the calibration process for the user to be displayed (Step S202).

Note that the processing in Steps S410 and S311 may be omitted so that the information processing device 50 causes the operation guide screen to be displayed in Step S202 after a predetermined time from Step S201. The predetermined time from Step S201 to Step S202 may be set according to, for example, an initialization time defined as a specification in the sensor 40.

FIG. 15C is a schematic diagram illustrating an example of the operation guide screen displayed by the information processing device 50. In FIG. 15C, the operation guide screen 60c is provided with an operation guide message 64 indicating a pedal operation method in the calibration to the user and a button 65 indicating acceptance of the operation guide message 64.

In this example, the operation guide message 64 gives an instruction for slowly pressing the soft pedal (pedal 30a) and the loud pedal (pedal 30b). In other words, in the calibration, it is necessary to operate each of the pedals 30a and 30b to such an extent that no inertial force is applied to the sensors 40, and this point of operation of the pedals without the inertial force is indicated to the user by the operation guide message 64.

Note that the content of the operation guide message 64 is not limited to this example. Furthermore, in FIG. 15C, the operation guide message 64 is illustrated as an example in which the casing 1 is mounted to each of the pedals 30a and 30b, but when the casing 1 is mounted to each of the pedals 30a, 30b, and 30c, the operation guide message 64 may have a content in which the pedals 30a, 30b, and 30c are reflected. As the operation guide message 64 indicated when the casing 1 is mounted to each of the pedals 30a, 30b, and 30c, for example, “Please slowly press all the pedals”, “Please slowly press the soft pedal, the loud pedal, and the sostenuto pedal”, or the like can be considered.

In response to the display of the operation guide screen 60c (Step S113), the user may start an operation (pedaling) on the pedals 30a and 30b (Step S103). The user performs an operation of pressing the pedals 30a and 30b to the maximum pedaling angle, from a state where the user's foot is removed from the pedals 30a and 30b, and then removing his/her foot from the pedals 30a and 30b. Note that the user may operate the pedals 30a and 30b at the same time or at different timing.

Meanwhile, when the initialization processing in Step S400 is completed, the sensor 40 starts measurement (Step S401). Outputs from the sensor 40 are sequentially transmitted to the signal processing device 20 (Step S411). The signal processing device 20 performs predetermined data processing including addition of the time information and the identification information for identifying each of the pedals 30a and 30b, to each of the sensor outputs transmitted from the sensor 40 (Step S301), and sequentially transmits the sensor outputs as the sensor data to the information processing device 50 (Step S312).

The information processing device 50 accumulates the sensor data transmitted from the signal processing device 20, in the storage device 5004 or the RAM 5002. Furthermore, the information processing device 50 displays a stop screen for stopping the pedal operation related to the calibration in response to operation of the button 65 on the operation guide screen 60c by the user (Step S203).

FIG. 15D is a schematic diagram illustrating an example of the stop screen displayed by the information processing device 50. In FIG. 15D, the stop screen 60d is provided with a STOP button 66 indicating that the pedal operation is stopped.

When the user removes the his/her foot from each of the pedals 30a and 30b and completes the pression operation of each of the pedals 30a and 30b for calibration, the user operates the STOP button 66 (Step S115) in response to the display of the stop screen 60d (Step S114). In response to the operation of the STOP button 66 on the stop screen 60d by the user, the information processing device 50 performs initialization calculation on the basis of the sensor data accumulated in Step S203 (Step S204).

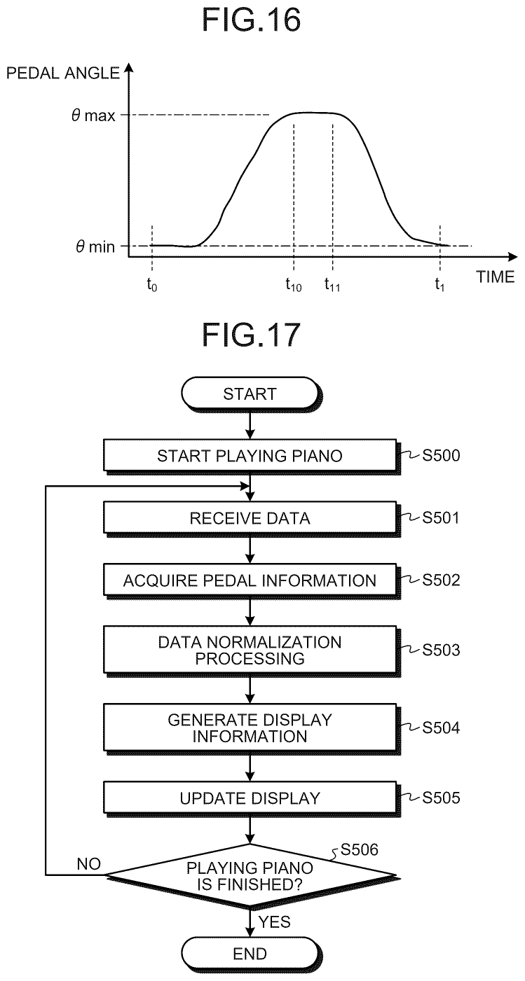

FIG. 16 is a graph schematically illustrating an exemplary relationship between elapsed time and pedal angle according to the pedal operation. In FIG. 16, the horizontal axis represents time, and the vertical axis represents pedal angle. Furthermore, in FIG. 16, the pedal 30 is illustrated focusing on the angle thereof in the gravity direction, for the sake of explanation.

In FIG. 16, time t₀ indicates the time at which the pedal operation in Step S104 is started. At time t₀, the foot is separated from the pedal 30, and the pedal angle in this state is defined as an angle θₘᵢₙ. It is assumed that when the user starts to press the pedal 30, the pedal angle gradually increases, and the pedal 30 is operated at the maximum pedaling angle between time t₁₀ and time t₁₁. The maximum pedaling angle in this state is defined as an angle θₘₐₓ. The user gradually removes his/her foot from the pedal 30 at time t₁₁, and the STOP button 66 is operated at time t₁.

In the initialization calculation in Step S204, the information processing device 50 obtains the pedaling angle relative to the pedal 30 by the calculation unit 510, on the basis of the sensor output included in the sensor data. The information processing device 50 performs initialization calculation on the basis of, for example, the angle θₘᵢₙ and the angle θₘₐₓ of the obtained pedaling angles, and normalizes the pedaling angle.

Furthermore, on the basis of the normalized pedaling angle, the information processing device 50 obtains a conversion coefficient to convert the sensor output into the normalized pedaling angle by the calculation unit 510. The information processing device 50 stores the conversion coefficient obtained in Step S204 in the storage device 5004 or the RAM 5002 (Step S205). A series of calibration process steps illustrated in FIG. 14 is completed by the processing in Step S205.

### 1-3-2. Process Example in Information Processing Device According to Embodiment

Next, an example of processing during playing the piano by the information processing device according to an embodiment will be described.

FIG. 17 is a flowchart illustrating an exemplary process during playing the piano by the information processing device according to an embodiment.

Note that it is assumed that the calibration process described with reference to FIG. 14 has been performed, prior to the process of the flowchart in FIG. 17. Furthermore, it is assumed that measurement by the sensor 40 has been performed, and the sensor data corresponding to the sensor output from the sensor 40 has been transmitted from the signal processing device 20 to the information processing device 50. Furthermore, it is assumed that the casing 1 including the fastener 10 and the sensor 40 has been mounted to each of the pedals 30a and 30b.

In FIG. 17, in Step S500, the user starts playing the piano in which the casing 1 is mounted to each of the pedals 30a and 30b.

In Step S501, the information processing device 50 receives the sensor data based on the sensor output from each sensor 40 corresponding to each of the pedals 30a and 30b and transmitted from the signal processing device 20. In the next Step S502, the information processing device 50 acquires the pedaling angle of each of the pedals 30a and 30b, as pedal information, on the basis of each piece of the received sensor data. In the next Step S503, the information processing device 50 normalizes the pedaling angle of each of the pedals 30a and 30b, on the basis of the conversion coefficient stored in Step S205 of FIG. 14.

In the next Step S504, the information processing device 50 generates display information for visualizing and presenting the pedaling angle to the user, on the basis of the pedaling angle of each of the pedals 30a and 30b normalized in Step S503. In the next Step S505, the information processing device 50 updates current display of the pedaling angle, according to the display information generated in Step S504.

In the next Step S506, the information processing device 50 determines whether playing the piano by the user or measurement of the pedaling angle of the pedal has been finished. In an example, the information processing device 50 may make this determination according to a predetermined user operation by the user whose piano playing or measurement of the pedaling angle of the pedal has finished. When it is determined that playing the piano by the user or the measurement of the pedaling angle of the pedal is finished (Step S506, “Yes”), the information processing device 50 finishes a series of process steps of the flowchart in FIG. 17.

On the other hand, when it is determined that playing the piano by the user or the measurement of the pedaling angle of the pedal is not finished, in Step S506 (Step S506, “No”), the information processing device 50 returns the process to Step S501. The processing in Steps S501 to S506 is repeated at predetermined time intervals (e.g., once per second).

### 1-3-3Display Example in Information Processing Device According to Embodiment

Next, an example of a display screen displayed in Steps S504 and S505 of the flowchart in FIG. 17 described above will be described.

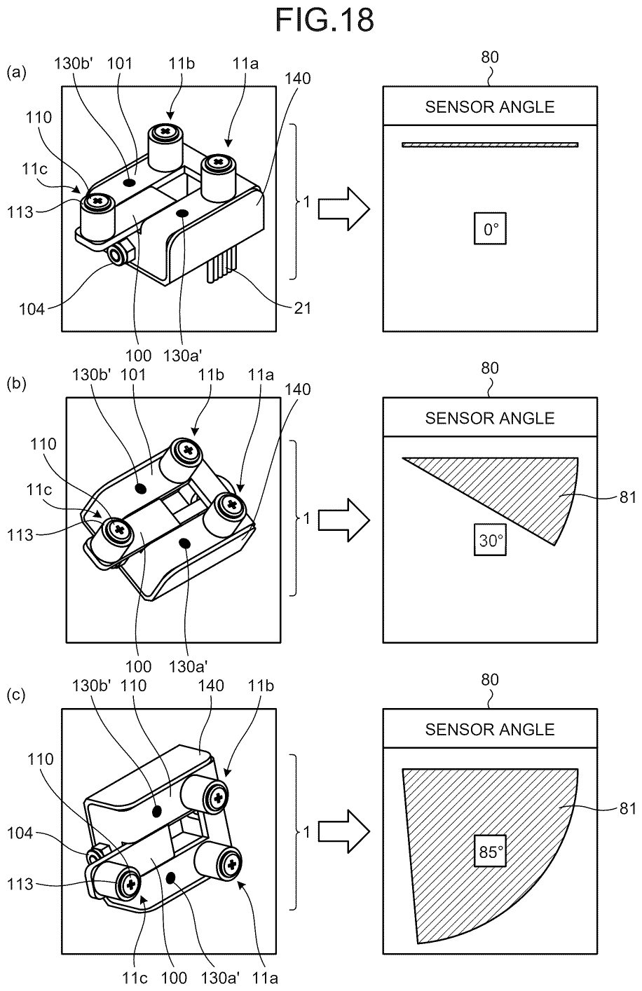

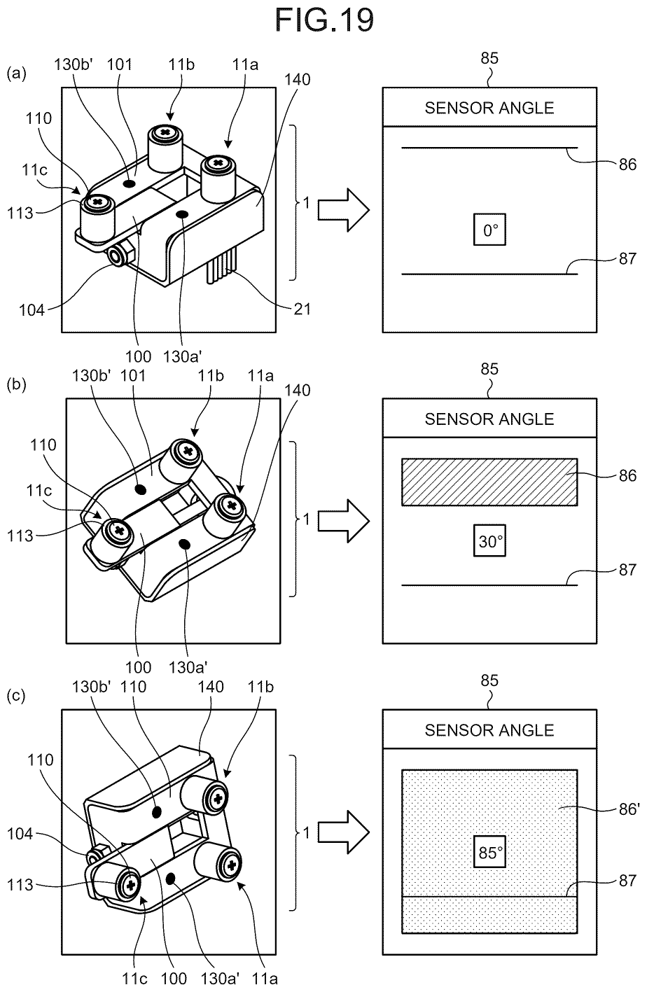

An example of visualization of the pedaling angle according to the attitude of the fastener 10 (casing 1) will be described with reference to FIGS. 18 and 19.

FIG. 18 is schematic diagrams each illustrating an example of direct display of angle corresponding to an attitude of the fastener 10, according to an embodiment. The sections (a) to (c) of FIG. 18 illustrate how the fastener 10 is being inclined perpendicularly to a plane of the fastener 10 as seen from the upper surface side, in a direction in which the pedal 30 is mounted, that is, a direction connecting the protrusions 11a and 11b. More specifically, the fastener 10 has an inclination angle α that is α=0° in the section (a), α=30° in the section (b), and α=85° in the section (c).

On the right sides of the sections (a) to (c) of FIG. 18, examples of display corresponding to the angles of the fastener 10 illustrated on the left side are illustrated. In the examples of the sections (a) to (c) of FIG. 18, each display 80 directly visualizes the angle of the fastener 10 by using a chart 81 with a fan shape. According to the display 80 of FIG. 18, the user can intuitively grasp the pedaling angle of the pedal 30.

FIG. 19 is schematic diagrams each illustrating an example of display of an angle according to an attitude of the fastener 10 by using a bar graph, according to an embodiment. Similarly to the sections (a) to (c) of FIG. 19, the sections (a) to (c) of FIG. 19 illustrate how the fastener 10 is being inclined perpendicularly to a plane of the fastener 10 as seen from the upper surface side, in a direction in which the pedal 30 is mounted. More specifically, the fastener 10 has an inclination angle α that is α=0° in the section (a), α=30° in the section (b), and α=85° in the section (c).

On the right sides of the sections (a) to (c) of FIG. 19, examples of display corresponding to the angles of the fastener 10 illustrated on the left side are illustrated. In the examples of the sections (a) to (c) of FIG. 19, each display 85 displays the angle of the fastener 10 by using a bar graph 86 extending from the upper end side toward the lower end side according to the angle. Furthermore, in this example, an indicator 87 indicating a threshold with respect to the angle is provided, and when the bar graph 86 has a length exceeding the indicator 87, a bar graph 86′ changed in color is displayed According to the display 85 of FIG. 18, the user can intuitively grasp that the pedaling angle of the pedal 30 has a value equal to or larger than a predetermined value.

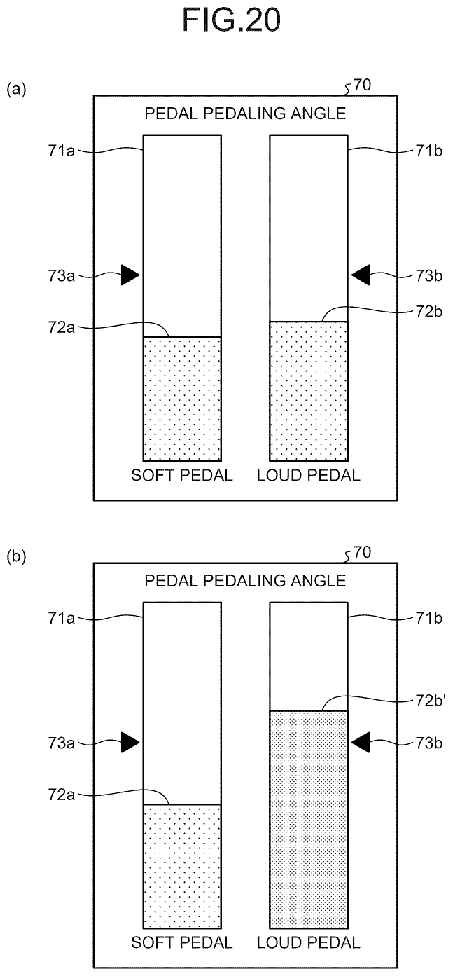

FIG. 20 is schematic diagrams each illustrating a more specific example of display of the angle by using a bar graph, which has been described with reference to FIG. 19. This example shows an example of the fasteners 10 (casings 1) mounted to the pedal 30a (soft pedal) and the pedal 30b (loud pedal).

The information processing device 50 causes an angle display screen 70 including display areas 71a and 71b to be displayed, as illustrated in the section (a) of FIG. 20. In the display area 71a, a bar graph 72a indicating the pedaling angle relative to the pedal 30a (soft pedal) is displayed. In the display area 71b, a bar graph 72b indicating the pedaling angle relative to the pedal 30b (loud pedal) is displayed.

In each example of FIG. 20, the information processing device 50 displays the bar graph 72a larger in height in the display area 71a, as the pedaling angle relative to the pedal 30a is larger. The same applies to the display area 71b. Furthermore, in each example of FIG. 20, the information processing device 50 may cause indicators 73a and 73b that indicate thresholds to be displayed, for the display areas 71a and 71b, respectively. When the pedaling angle is larger than the threshold, the information processing device 50 may display a bar graph 72b′ having a display a color different from that of the bar graph 72b indicating the pedaling angle equal to or smaller than the threshold, as illustrated in the display area 71b in the section (b) of FIG. 20.

Note that the information processing device 50

may change the display of the angle display screen 70 depending on the casings 1 mounted to the pedals 30a to 30c. When the casing 1 is mounted only to the pedal 30a of the pedals 30a to 30c, the information processing device 50 may cause, for example, only the display area 71a to be displayed on the angle display screen 70. Furthermore, for example, when the casing 1 is mounted to all of the pedals 30a to 30c, the information processing device 50 may cause the angle display screen 70 in which a display area for displaying a bar graph corresponding to the pedal 30c is added to the display areas 71a and 71b to be displayed. The information processing device 50 is configured to recognize whether the casing 1 is mounted to which pedal of the pedals 30a to 30c, for example, on the basis of the identification information included in the sensor data transmitted from the signal processing device 20.

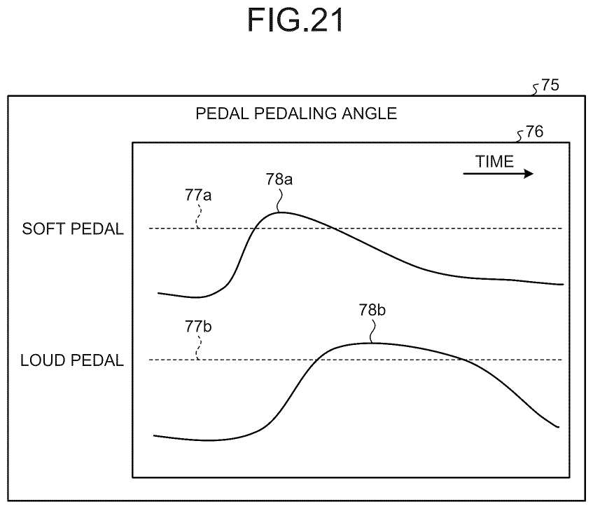

FIG. 21 is a schematic diagram illustrating an example of the angle display screen showing a temporal change in pedaling angle according to an embodiment. Similarly to FIG. 20, also in this example, the fastener 10 (casing 1) is mounted to each of the pedal 30a (soft pedal) and the pedal 30b (loud pedal).

In FIG. 21, an angle display screen 75 includes a display area 76 in which charts each showing a time variation in the pedaling angle of the pedal 30a (soft pedal) and the pedal 30b (loud pedal) are displayed. In each of the charts, the horizontal axis indicates time with the left end as the current time, and the vertical axis indicates the pedaling angle. In the charts, a characteristic line 78a indicates the time variation in the pedaling angle of the pedal 30a, and a characteristic line 78b indicates the time variation in the pedaling angle of the pedal 30b. In addition, indicators 77a and 77b each indicating a threshold of the pedaling angle are displayed on the charts.

Note that the information processing device 50 may change the display of the angle display screen 70 depending on the casings 1 mounted to the pedals 30a to 30c. When the casing 1 is mounted only to the pedal 30a of the pedals 30a to 30c, the information processing device 50 may cause, for example, only information corresponding to the pedal 30a to be displayed on the angle display screen 70 or 75. Furthermore, for example, when the casing 1 is mounted to all of the pedals 30a to 30c, the information processing device 50 may cause the angle display screen 70 or 75 to display information corresponding to the pedals 30a to 30c. The information processing device 50 is configured to recognize whether the casing 1 is mounted to which pedal of the pedals 30a to 30c, for example, on the basis of the identification information included in the sensor data transmitted from the signal processing device 20.

The information processing device 50 is configured to use the angle display screen 70 or 75 described above to present the pedaling angle of each of the pedals 30a to 30c to the user (player) in real time.

In addition, registering in advance the pedaling angle at which each of the pressed pedals 30a to 30c generates an effect, as the threshold, alert can be displayed when the pedaling angle exceeds the threshold, as illustrated as the bar graph 72b′ having the different display color in the section (b) of FIG. 20. In an example, for the pedal 30b being the loud pedal, the pedaling angle at which the dampers are fully raised by pressing the pedal 30b may be registered as the threshold.

The alert may be displayed at the moment when the pedaling angle exceeds the threshold, or may be displayed when a state in which the pedaling angle exceeds the threshold is continued for a certain period of time. In addition, in the example of FIG. 20, the alert is presented by changing the color of the bar graph 72b, but the alert is not limited to this example. For example, the information processing device 50 may have a configuration to output sound, such as a speaker, to give a sound alert. In addition, the display or the sound alert performed when the pedaling angle exceeds the threshold can be similarly applied to the example of time-series display of pedaling angle illustrated in FIG. 21.

In an example, in actual piano lesson, the user may be taught about keeping pressing the pedal 30. In such a case, use of the angle display screens 70 and 75 that display visualized pedaling angle of the pedal 30 is promising.

In the above, it has been described that the casing 1 including the fastener 10 and the sensor 40 is mounted to the pedal 30 of the grand piano, but the present disclosure is not limited to this example. In other words, the casing 1 according to an embodiment may be mounted to each of the pedals 30 for assistance for playing the piano, provided at an upright piano. Furthermore, in the above, it has been described that the casing 1 is mounted to the pedal 30 of the acoustic piano, but the present disclosure is not limited to this example. For example, the casing 1 according to an embodiment may be mounted to each pedal 30 for assistance for playing the piano, provided at a so-called electronic piano that outputs electronically produced sound.

Note that the effects described herein are merely examples and are not limited to the descriptions, and other effects may be provided.

Note that the present technology can also have the following configurations.
(1) A detection device comprising:
   a casing;
   a fastener that is included in the casing and removably fixes the casing to at least one pedal for assistance for playing a piano; and
   a sensor that is included in the casing and detects an attitude of the casing.
(2) The detection device according to the above (1), wherein
   the fastener includes:
   a first protrusion that is provided at a first end portion of a first member;
   a second protrusion that is provided at a second end portion opposed to the first end portion of a second member movably combined with the first member along a side connecting the first end portion of the first member and an opposite end portion to the first end portion; and
   an adjustment unit that adjusts a distance between the first protrusion and the second protrusion, and
   the first protrusion and the second protrusion hold the pedal to fix the casing to the pedal.
(3) The detection device according to the above (2), wherein
   the second member is movably combined with the first member across the first member, along a first side and a second side connecting the first end portion of the first member of the first member and the opposite end portion to the first end portion, and
   the second protrusion is provided at each of a portion of the second member near the first side and a portion of the second member near the second side.
(4) The detection device according to the above (2) or (3), wherein
   the first protrusion and the second protrusion are removably provided on the first member and the second member, respectively.
(5) The detection device according to any one of the above (2) to (4), wherein
   in the second member,
   a structure in which the second protrusion is allowed to be installed is provided between a position corresponding to the first end portion and the second end portion.
(6) The detection device according to any one of the above (2) to (5), wherein
   the first protrusion and the second protrusion have curved side surfaces that protrude from the first member and the second member, respectively.
(7) The detection device according to any one of the above (2) to (5), wherein
   the adjustment unit converts rotational movement of a shaft portion of a screw into linear movement to adjust the distance between the first protrusion and the second protrusion.
(8) The detection device according to any one of the above (1) to (7), further comprising
   a communication unit that adds at least time information to an output from the sensor and transmits the output.
(9) The detection device according to any one of the above (1) to (8), wherein
   the casing is fixed to each of at least a loud pedal and a soft pedal of the at least one pedal by the fastener.
(10) The detection device according to any one of the above (1) to (8), wherein
   the casing is fixed to each of a loud pedal, a soft pedal, and a sostenuto pedal of the at least one pedal by the fastener.
(11) A detection method executed by a processor, the method comprising:
   a calculation step of calculating a pedaling angle of a pedal for assistance for playing a piano, on the basis of an output from a sensor of a detection device including a casing, a fastener included in the casing to removably fix the casing to the pedal, and a sensor included in the casing to detect an attitude of the casing.
(12) The detection method according to the above (11), wherein
   the casing is fixed to each of one or more of the pedals, and
   the calculation step includes calculating the pedaling angle for each pedal, based on the output from the sensor of each casing.
(13) The detection method according to the above (12), wherein
   the casing is fixed to each of at least a loud pedal and a soft pedal of the pedals by the fastener.
(14) The detection method according to the above (12), wherein
   the casing is fixed to each of a loud pedal, a soft pedal, and a sostenuto pedal of the pedals by the fastener.
(15) The detection method according to any one of the above (11) to (14), wherein
   the calculation step includes
   calculating the pedaling angle normalized based on the output from the sensor in a state where a user does not press the pedal and the output from the sensor in a state where the user maximally presses the pedal.
(16) The detection method according to any one of the above (11) to (15), further comprising
   a generation step of generating a screen that presents the pedaling angle calculated in the calculation step to a user.
(17) The detection method according to the above (16), wherein
   the generation step includes
   generating the screen that presents a temporal change in the pedaling angle to a user based on time information indicating time corresponding to the output from the sensor.
(18) The detection method according to the above (16) or (17), wherein
   the generation step includes
   generating the screen including a threshold for the pedaling angle.
(19) The detection method according to the above (18), wherein
   the generation step includes
   presenting alert when the pedaling angle exceeds the threshold.

### REFERENCE SIGNS LIST

1 CASING
10 FASTENER
11a, 11b, 11c PROTRUSION
20 SIGNAL PROCESSING DEVICE
21, 22 CABLE
30, 30a, 30b, 30c PEDAL
31 PEDAL BOX
40 SENSOR
60a INITIAL SCREEN
60b STANDBY MESSAGE SCREEN
60c OPERATION GUIDE SCREEN
60d STOP SCREEN
70, 75 ANGLE DISPLAY SCREEN
72a, 72b, 72b′, 86, 86′ BAR GRAPH
73a, 73b, 77a, 77b, 87 INDICATOR
100 FIRST MEMBER
101 SECOND MEMBER
102 BOLT
103 KNOB
104 NUT
110 SCREW
111, 130a, 130a′, 130b, 130b′, 130c SCREW HOLE
112 FIRST CYLINDRICAL MEMBER
113 SECOND CYLINDRICAL MEMBER
121, 122, 123 HOLE PORTION
140 COVER
200a, 200b, 200c I/F UNIT
201 SIGNAL PROCESSING UNIT
202, 500 CONTROL UNIT
203, 501 COMMUNICATION UNIT
503 DISPLAY UNIT
510 CALCULATION UNIT

1. A detection device comprising:
a casing;
a fastener that is included in the casing and removably fixes the casing to at least one pedal for assistance for playing a piano; and
a sensor that is included in the casing and detects an attitude of the casing.

2. The detection device according to claim 1, wherein
the fastener includes:
a first protrusion that is provided at a first end portion of a first member;
a second protrusion that is provided at a second end portion opposed to the first end portion of a second member movably combined with the first member along a side connecting the first end portion of the first member and an opposite end portion to the first end portion; and
an adjustment unit that adjusts a distance between the first protrusion and the second protrusion, and
the first protrusion and the second protrusion hold the pedal to fix the casing to the pedal.

3. The detection device according to claim 2, wherein
the second member is movably combined with the first member across the first member, along a first side and a second side connecting the first end portion of the first member of the first member and the opposite end portion to the first end portion, and
the second protrusion is provided at each of a portion of the second member near the first side and a portion of the second member near the second side.

4. The detection device according to claim 2, wherein
the first protrusion and the second protrusion are removably provided on the first member and the second member, respectively.

5. The detection device according to claim 2, wherein
in the second member,
a structure in which the second protrusion is allowed to be installed is provided between a position corresponding to the first end portion and the second end portion.

6. The detection device according to claim 2, wherein
the first protrusion and the second protrusion have curved side surfaces that protrude from the first member and the second member, respectively.

7. The detection device according to claim 2, wherein
the adjustment unit converts rotational movement of a shaft portion of a screw into linear movement to adjust the distance between the first protrusion and the second protrusion.

8. The detection device according to claim 1, further comprising
a communication unit that adds at least time information to an output from the sensor and transmits the output.

9. The detection device according to claim 1, wherein
the casing is fixed to each of at least a loud pedal and a soft pedal of the at least one pedal by the fastener.

10. The detection device according to claim 1, wherein
the casing is fixed to each of a loud pedal, a soft pedal, and a sostenuto pedal of the at least one pedal by the fastener.

11. A detection method executed by a processor, the method comprising:
a calculation step of calculating a pedaling angle of a pedal for assistance for playing a piano, on the basis of an output from a sensor of a detection device including a casing, a fastener included in the casing to removably fix the casing to the pedal, and a sensor included in the casing to detect an attitude of the casing.

12. The detection method according to claim 11, wherein
the casing is fixed to each of one or more of the pedals, and
the calculation step includes calculating the pedaling angle for each pedal, based on the output from the sensor of each casing.

13. The detection method according to claim 12, wherein
the casing is fixed to each of at least a loud pedal and a soft pedal of the pedals by the fastener.

14. The detection method according to claim 12, wherein
the casing is fixed to each of a loud pedal, a soft pedal, and a sostenuto pedal of the pedals by the fastener.

15. The detection method according to claim 11, wherein
the calculation step includes
calculating the pedaling angle normalized based on the output from the sensor in a state where a user does not press the pedal and the output from the sensor in a state where the user maximally presses the pedal.

16. The detection method according to claim 11, further comprising
a generation step of generating a screen that presents the pedaling angle calculated in the calculation step to a user.

17. The detection method according to claim 16, wherein
the generation step includes
generating the screen that presents a temporal change in the pedaling angle to a user based on time information indicating time corresponding to the output from the sensor.

18. The detection method according to claim 16, wherein
the generation step includes
generating the screen including a threshold for the pedaling angle.

19. The detection method according to claim 18, wherein
the generation step includes
presenting alert when the pedaling angle exceeds the threshold.
